(19) United States
(12) Patent Application Publication
(10) Pub. No.: US 2005/0229368 A1
(43) Pub. Date: Oct. 20, 2005

(54) Cloth and method for manufacturing a cloth at least one permanent fold.

(76) Inventor: Marc Moons, Reet (BE)

Correspondence Address: BACON & THOMAS, PLLC, 625 SLATERS LANE, FOURTH FLOOR, ALEXANDRIA, VA, 22314, US

(21) Appl. No.: 10/508,697

(22) PCT Filed: Apr. 16, 2003
(86) PCT No.: PCT/BE03/00066

§ 371 Date: Sep. 29, 2004

(30) Foreign Application Priority Data
Apr. 18, 2002 (BE) 2002/0267

(51) Int. Cl. D06M 10/00; B32B 3/30; B32B 3/28

(52) U.S. Cl. 28/165; 428/181

(57) ABSTRACT

Cloth designed to be provided with at least one permanent fold, characterised in that at least in one folding zone (6), a shrink material (8) is anchored in it in one direction which can be shrunk in a direction which is diagonal to the aforesaid direction as a result of a treatment.

The present invention concerns a cloth.

The invention in particular concerns a cloth designed to be provided with at least one permanent fold.

In some cases it is desirable or necessary that a cloth has one or several folds. Thus, in some cases, a zigzag folded cloth is required.

The cloths are usually woven flat, and the folds are formed only afterwards. When the cloth is woven out of thermoplastic synthetic fibres, permanent folds can be obtained for example by means of a thermal treatment. However, this is time-consuming and it is not always possible to obtain a nice fold; moreover, these folds tear too quickly when they are frequently opened and closed.

The invention aims a cloth which makes it possible to form at least one permanent fold in it in a simple and fast manner.

This aim is reached according to the invention in that in the cloth, at least in one folding zone, a shrink material is anchored in one direction which can be shrunk in a direction which is diagonal to the aforesaid direction as a result of a treatment.

From Japanese patent No. 09-023967, registered in the name of Unitika Ltd., published on Jan. 28th 1997, a ribbon is known in which shrinkable threads are woven in, which shrink after being boiled. The shrinkable threads extend in the longitudinal direction of the ribbon and are locally bound in. The ribbon is stitched on a curtain, and the curtain is put in water which is made to boil. As the shrink threads shrink, loops are formed in the ribbon to form the curtain hooks.

The cloth is preferably a fabric, for example a gauze.

Moreover, the shrink material in the folding zone is preferably provided in the direction of the warp.

Naturally, also the folding zone will be directed in this direction of the warp.

The shrink material preferably has one shrink thread provided in a zigzag manner in the folding zone, for example bound in in the fabric.

In the cloth may be anchored one or several folding threads in said folding zone.

The present invention also concerns a method for manufacturing a cloth with at least one permanent fold.

This method is characterised in that a cloth according to any of the preceding embodiments is taken as a basis, i.e. a cloth containing a shrink material in every folding zone, in other words there where a fold is to be formed, which can be shrunk by means of a treatment in the direction which is diagonal to the fold, and in that said cloth is subjected to the above-mentioned treatment.

A woven cloth is preferably taken as a basis in which the shrink material is provided in the direction of the warp threads, or also a knitted cloth.

A cloth in which the shrink material contains at least one shrink thread for every fold, provided in a zigzag manner, preferably woven in in the direction of the warp, can be taken as a basis.

The cloth which is taken as a basis may have at least one folding thread in every folding zone, over which the shrink material has been provided, for example over which the shrink thread has been bound in in a zigzag manner.

In order to better explain the characteristics of the invention, the following preferred embodiment of a cloth and a method for manufacturing a cloth with at least one. permanent fold according to the invention as described as an example only without being limitative in any way, with reference to the accompanying drawings, in which:

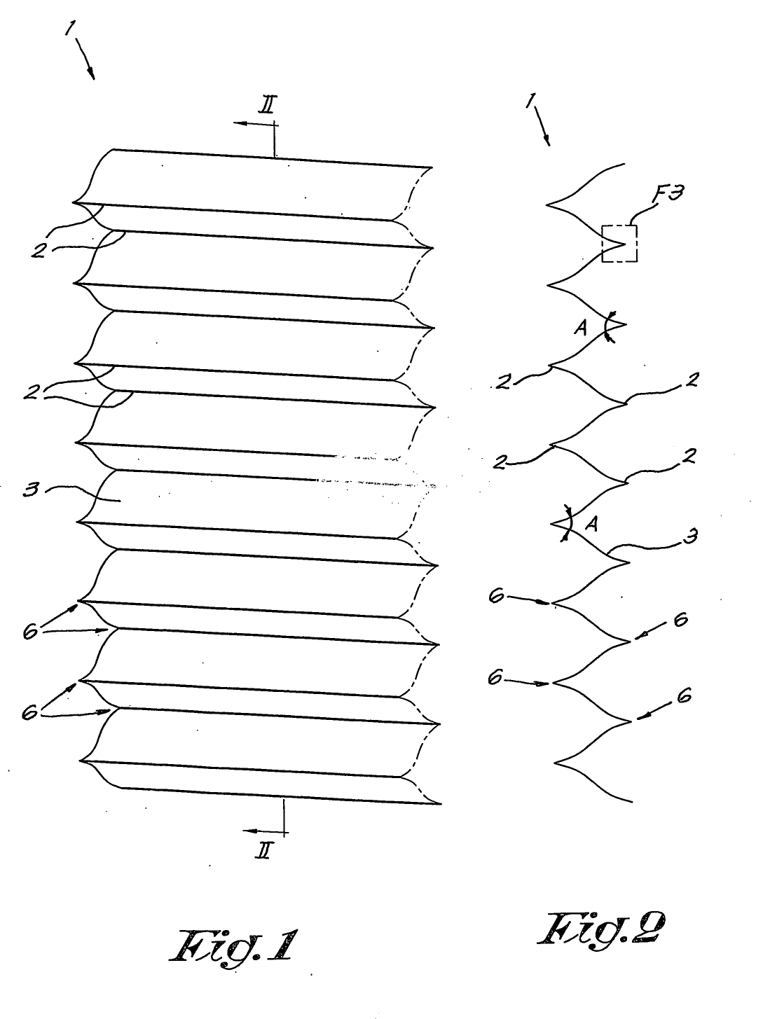

FIG. 1 schematically represents a view in perspective of a cloth with folds, manufactured according to the method of the invention;

FIG. 2 represents a section according to line II-II in FIG. 1;

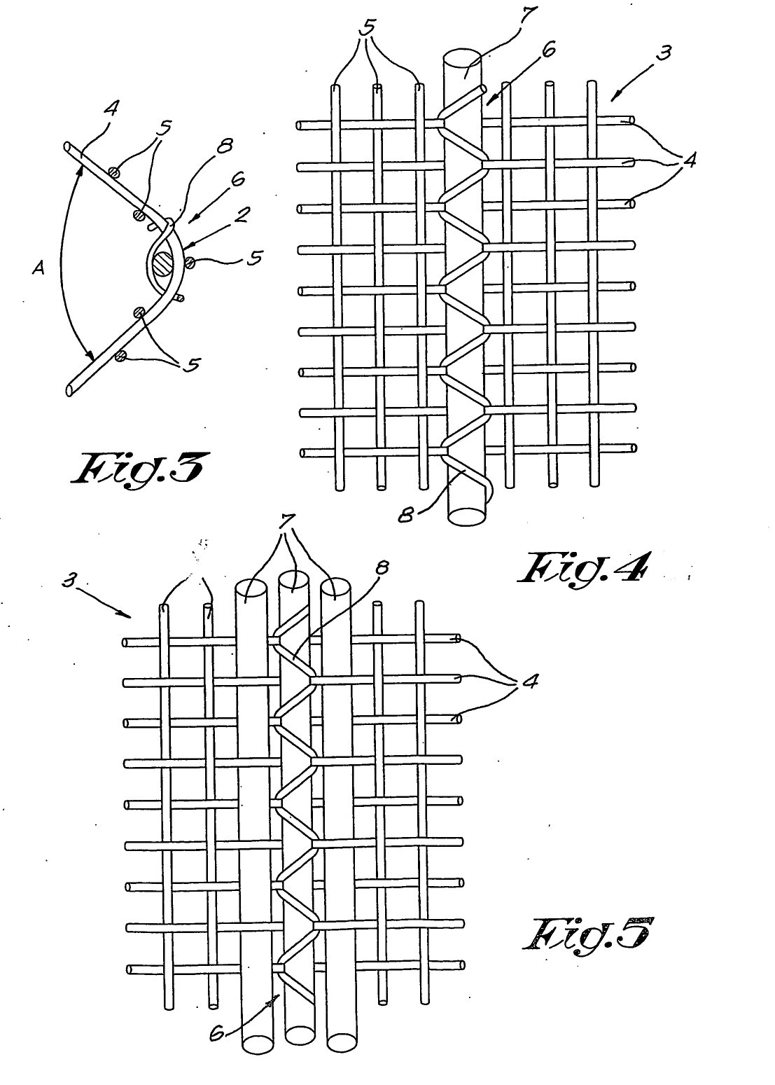

FIG. 3 represents the part indicated with F3 in FIG. 2 to a larger scale;

FIG. 4 represents a piece of the fabric material used for manufacturing the cloth of the preceding figures;

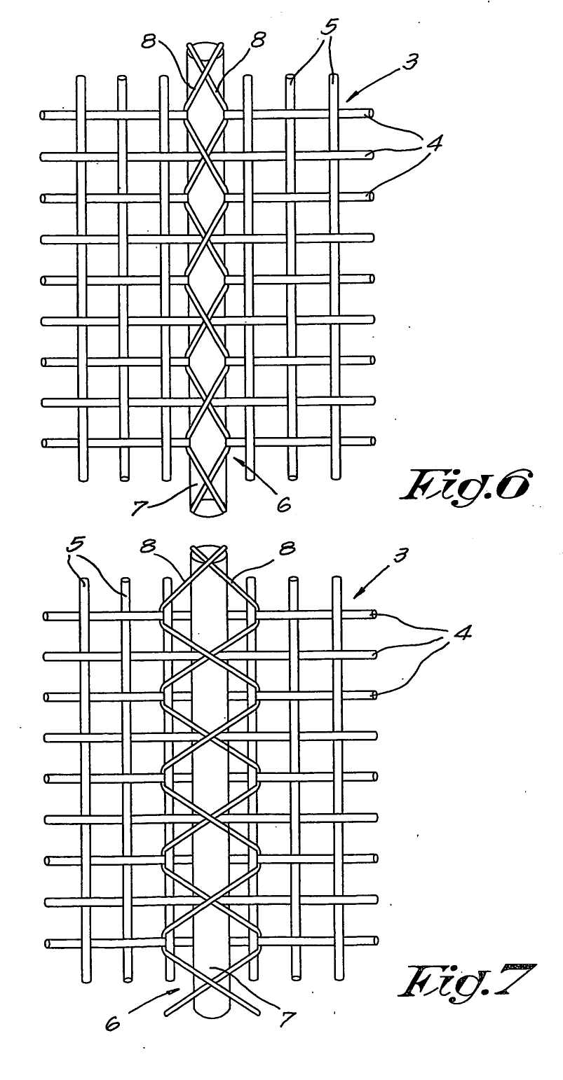

FIGS. 5 to 7 each represent a piece of the fabric material analogous to that in FIG. 3, but with reference to other embodiments of the invention.

FIGS. 1 and 2 represent a piece of wire gauze of an insect screen 1 folded in a zigzag manner, whose permanent folds 2, situated at regular distances from one another, are obtained in the following manner:

A cloth 3 is taken as a basis, in this case a woven gauze to be more precise, which has been woven in the conventional manner from weft threads 4 bound in with warp threads 5, but whereby, as represented in FIG. 4, in folding zones 6 where a fold 2 is to be formed, a folding thread 7 has been woven in as a warp thread by means of a shrink thread 8 that has been woven in according to the technique of the staggering warp threads.

The term ‘thread’ has to be interpreted in a broad sense here, which implies that monofilaments as well as yarns or mixtures thereof are to be understood by it. The yarns can be spun yarns or filament yarns, either or not textured, and even elastic yarns. The thread may consist of natural material as well as of synthetic material or a combination thereof, and it can possibly be provided with a coating. The warp threads and the weft threads can be made of different materials.

The shrink thread 8 is a thread which, under the influence of a thermal, mechanical/thermal, ultrasonic, high-frequency or another appropriate treatment, undergoes a permanent longitudinal shrinkage, preferably of minimum 5%.

This shrink thread is preferably spun of yarn which consists, partly or as a whole, of one or several synthetic fibres, of continuous filament yarn, consisting of one or several synthetic filaments, of monofilament consisting of one or several synthetic base materials, or of elastic yarns or filaments.

Said shrink thread 8, as it is woven in, is anchored in the folding zone on either side of the middle of the zigzag form, i.e. the place where the folding is to take place, and it thus extends in the direction of the warp in a zigzag manner over the folding thread 7 which is thus enclosed by the shrink thread 8 on one side. In case of shrinkage, the shrink thread 8 will mainly shrink in a direction diagonal to the folding zone 6 and thus to the fold 2 to be formed.

Said folding thread 7, which may be formed of the above-mentioned ‘thread’ materials, reinforces or supports the formation of the fold and preferably has a larger diameter than the warp threads 5. This folding thread 7 can be provided on top of an ordinary warp thread 5, or the warp thread 5 can be omitted there where a folding thread 7 is provided.

The above-described cloth 3 was subjected to the treatment whereby the shrink threads 8 shrink. It is clear that, as a result of this shrinkage, parts of the weft threads 4 are drawn towards each other on either side of said folding thread 7, so that the weft threads 4 are folded, as is represented in FIG. 3. The shrinkage is irreversible, which implies that the formed fold 2 is permanent.

It is clear that the folding of the weft threads 4 towards one or other side of the cloth 3 depends on how the shrink thread 8 is woven in. In the given embodiment, whereby the shrink thread 8 is provided over a folding thread 7, the direction of the fold 2 depends on what side said folding thread 7 is situated along in relation to the weft threads 4 and the shrink thread 8.

This implies that, in the wire gauze of an insect screen 1, the shrink threads 8 forming the basis of the successive folds 2 are alternately woven in over a folding thread 7 on either side of the cloth 3, such that this cloth 3 is folded in a zigzag manner.

The magnitude of the shrinkage and the size of the zigzag movement of the shrink thread 8 determines the opening of the folds 2 or, in other words, how strong the parts of a weft thread 4 situated next to the folding thread 7 are drawn towards each other, and thus the size of the angle A between these neighbouring parts if they are free to diverge.

Naturally, the folds 2 can be pushed together, so that the parts of the wire gauze of an insect screen 1 situated between the successive folding threads 7 are brought together, whereby the above-mentioned angle A is thus practically reduced to zero.

It is clear that also the shrink threads 8, instead of being woven in, can be stitched on after the weaving, or can also be anchored by means of other anchoring techniques. The same applies to the folding threads 7.

According to a variant, the shrink threads 8 are replaced by shrink strips which shrink crosswise when being subjected to a treatment as mentioned for the shrink threads 8 and which are fixed on the cloth 3, preferably after the weaving, by one or other anchoring process such as stitching, gluing or the like.

According to a variant, a cloth 3 is taken as a basis having more than one folding thread 7 in every folding zone 6. FIG. 5 represents such a cloth 3 with three folding threads 7 that are woven in next to one another. The shrink thread 8 is only woven in over the middle folding thread 7, but naturally, according to another variant, said shrink thread 8 can be woven in over the three folding threads 7.

Not only can there be more than one folding thread 7 in the folding zone 6, it is also possible that there is no folding thread 7 whatsoever. The function of this folding thread 7 is then assumed for example by an ordinary warp thread 5.

According to another variant, a cloth 3 as represented in FIG. 6 is taken as a basis. This cloth 3 differs from the cloth 3 in FIG. 4 in that, in every folding zone 6 where a fold is to be formed, two shrink threads 8 are woven in over the folding thread 7 in a zigzag manner in the opposite sense.

According to yet another variant, a cloth 3 as represented in FIG. 7 is taken as a basis. This cloth 3 differs from the cloth 3 represented in FIG. 6 in that the two shrink threads 8 are woven in in a different manner. Indeed, these shrink threads 8 are bound in with the weft threads 4 around warp threads 5 situated next to the folding thread 7.

A cloth 3 with permanent folds 2 is obtained, also according to the above-described variants of the cloth 3, in the above-described manner by applying the treatment which makes the shrink threads 8 shrink.

In all the above-described embodiments is obtained a wire gauze of an insect screen with folds 2 retaining their shape, formed in the direction of the warp, which can be opened in a flexible manner.

The cloth 3 must not necessarily be a gauze. It can be any other fabric whatsoever, with any weave whatsoever between the weft threads 4 and the warp threads 5. The cloth 3 must not even necessarily be a fabric. It can also be a knitting or even a non-woven. In the latter case, the shrink threads 8 and the possible folding threads 7 must be provided after the non-woven has been manufactured.

Further, the cloth 3 provided with folds 2 must not necessarily be a wire gauze of an insect screen 1. It can also be a sun screen, a curtain, packaging material, a carrier bag, an attaché-case or a part thereof, the lining of a suitcase, a filtering cloth or, as a matter of fact, any object made of fabric material provided with one or several permanent folds.

The invention is by no means limited to the above-described embodiment represented in the accompanying drawings; on the contrary, such a cloth and such a method for manufacturing a cloth with at least one permanent fold can be made in all sorts of variants while still remaining within the scope of the invention.

1. Cloth designed to be provided with at least one permanent fold, characterised in that at least one folding zone (6), a shrink material (8) is anchored in it in one direction which can be shrunk in a direction which is diagonal to the aforesaid direction as a result of a treatment.

2. Cloth according to claim 1, characterised in that it is a fabric.

3. Cloth according to claim 2, characterised in that the shrink material (8) is provided in the folding zone (6) in the direction of the warp.

4. Cloth according to claim 1, characterised in that it is a knitting.

5. Cloth according to claim 1 characterised in that the shrink material comprises at least one shrink thread (8) provided in the folding zone (6) in a zigzag manner.

6. Cloth according to claim 2, wherein the shrink thread (8) is woven in.

7. Cloth according to claim 2, wherein the shrink thread (8) is woven in according to the technique of the staggering warp threads.

8. Cloth according to claim 1, wherein at least one folding thread (7) is anchored in the folding zone (6).

9. Cloth according to claim 1, wherein in the above-mentioned folding zone (6), one or several folding threads (7) are bound in the direction of the warp, whereby the shrink thread (8) is provided in a zigzag manner over at least one of these folding threads (7).

10. Method for providing at least one permanent fold (2) in a cloth (3), characterised in that a cloth (3) according to claim 1 is taken as a basis.

11. Method for providing at least one permanent fold (2) in a cloth (3), characterised in that a cloth (3) is taken as a basis containing a shrink material (8) in every folding zone (6), in other words there where a fold (2) is to be formed, which can be shrunk by means of a treatment in the direction which is diagonal to the fold (2), and in that said cloth (3) is subjected to the above-mentioned treatment.

12. Method according to claim 11, characterised in that a woven cloth (3) is taken as a basis.

13. Method according to claim 12, characterised in that a cloth (3) is taken as a basis in which the shrink material (8) is provided in the direction of the warp threads (5).

14. Method according to claim 11, wherein the shrink material in every folding zone (6) comprises at least one shrink thread (8) which has been anchored in a zigzag manner.

15. Method according to claim 11, wherein a cloth (3) is taken as a basis having at least one folding thread (7) in every folding zone (6) over which the shrink material (8) has been provided.

16. Method according to claim 11, wherein a cloth (3) is taken as a basis forming a gauze.

17. Method according to claim 11, wherein a cloth (3) is taken as a basis having several folding zones (6) at regular distances from one another, and in that as a result of the treatment causing the shrink material (8) in these folding zones (6) to shrink, a cloth folded in a zigzag manner is manufactured.

18. Method according to claim 17, wherein a wire gauze of an insect screen is formed.

19. Method according to claim 11, wherein the cloth (3) is subjected to a thermal, mechanical/thermal, ultrasonic or high-frequency treatment to make the shrink material (8) shrink.
